(19) United States
(12) Patent Application Publication
(10) Pub. No.: US 2013/0089051 A1
(43) Pub. Date: Apr. 11, 2013

(54) METHOD AND APPARATUS FOR DATA TRANSMISSION IN RADIO NETWORK

(71) Applicant: Huawei Technologies Co., Ltd., Shenzhen (CN)

(72) Inventors: Wei Bai, Shenzhen (CN); Juan Zheng, Shenzhen (CN); Zhiyu Yan, Shenzhen (CN)

(73) Assignee: Huawei Technologies Co., Ltd., Shenzhen (CN)

(21) Appl. No.: 13/689,156

(22) Filed: Nov. 29, 2012

Related U.S. Application Data
(63) Continuation of application No. PCT/CN2011/074837, filed on May 30, 2011.

(30) Foreign Application Priority Data
May 29, 2010 (CN) 201010190407.7

(51) Int. Cl. H04W 52/24

(52) U.S. Cl. CPC H04W 52/243
USPC 370/329

(57) ABSTRACT

The disclosure provides a method and apparatus for data transmission in a radio network. The method includes: a first access point sends transmission information of a data channel allocated to a user terminal to a second access point, enabling the second access point sending data to the user terminal through the data channel according to the transmission information of the data channel, where the first access point sends no data through the data channel, or sends data through the data channel to other user terminals than the user terminal through the data channel at a transmit power less than or equal to a first power. The technical solution of the present disclosure can avoid channel interference between the second access point and the first access point in a heterogeneous network scenario, and improve transmission performance.

### CROSS-REFERENCE TO RELATED APPLICATIONS

This application is a continuation of International Application No. PCT/CN2011/074837, filed on May 30, 2011, which claims priority to Chinese Patent Application No. 201010190407.7, filed on May 29, 2010, both of which are hereby incorporated by reference in their entireties.

### FIELD

The present disclosure relates to the field of communication technologies and, in particular, to a method and apparatus for data transmission in a radio network.

### BACKGROUND

The heterogeneous network technology is applied in the LTE (Long Term Evolution—Advanced) system widely due to supporting coverage of high data rate transmission and providing good user coverage. The heterogeneous network defined in the 3GPP LTE-A standard refers to a network composed of different power nodes. Such power nodes include: macro eNodeB, micro eNodeB, home eNodeB, relay station, and so on.

In a heterogeneous network, the user terminal may demodulate a control channel of the serving node correctly first, and receives data transmission scheduling information from the serving node through the control channel, and then uses the data transmission scheduling information to receive service data from the serving node.

In a heterogeneous network, the use of a low-power serving node makes the interference scene in the heterogeneous network different from that in a homogeneous network. For example, the transmit power of a macro eNodeB is generally 46 dBm, but the transmit power of the micro eNodeB is only 30 dBm. Obviously, the transmit power differs sharply between the macro eNodeB and the micro eNodeB, and a user terminal served by the micro eNodeB receives interference from the macro eNodeB. Therefore, to ensure the user terminal in a heterogeneous network to work normally, it is necessary to avoid the interference between nodes of different powers.

### SUMMARY

Embodiments of the present disclosure provide a method and apparatus for data transmission in a radio network to avoid the interference between different access points in a radio network system.

A method for data transmission in a radio network is provided in an embodiment of the present disclosure. The method includes:
sending, by a first access point, transmission information of a data channel allocated to a user terminal to a second access point,
enabling the second access point sending data to the user terminal through the data channel according to the transmission information of the data channel;
where the first access point sends no data through the data channel, or sends data to other user terminals than the user terminal through the data channel at a transmit power less than or equal to a first power.

A method for data transmission in a radio network is provided in an embodiment of the present disclosure. The method includes:
receiving, by a second access point, transmission information of a data channel allocated by a first access point to a user terminal, and
sending, by the second access point, data to the user terminal through the data channel according to the transmission information of the data channel;
wherein the first access point sends no data through the data channel, or sends data to other user terminals than the user terminal through the data channel at a transmit power less than or equal to a first power.

Further, a first access point in a radio network is provided in an embodiment of the present disclosure. The first access point includes:
a processor, configured to allocate transmission information of a data channel; and
a transmitter, configured to send to a second access point the transmission information of the data channel allocated to the user terminal, where
the first access point sends no data through the data channel, or sends data to other user terminals than the user terminal through the data channel at a transmit power less than or equal to a first power.

Further, a second access point in a radio network is provided in an embodiment of the present disclosure. The second access point includes:
a receiver, configured to receive transmission information of a data channel allocated by a first access point to a user terminal; and
a transmitter, configured to send data to the user terminal through the data channel according to the transmission information of the data channel, where
the first access point sends no data through the data channel, or sends data to other user terminals than the user terminal through the data channel at a transmit power less than or equal to a first power.

Further, a method for data transmission in a radio network is provided in an embodiment of the present disclosure. The method includes:
receiving, by a user terminal, transmission information of a data channel allocated by a first access point to the user terminal; and
receiving, by the user terminal, data sent by a second access point according to the transmission information of the data channel;
wherein
the data is sent by the second access point through the data channel according to the transmission information of the data channel, and
the first access point sends no data through the data channel, or sends data to other user terminals than the user terminal through the data channel at a transmit power less than or equal to a first power.

Further, a user terminal provided in an embodiment of the present disclosure includes:
a receiver, configured to receive transmission information of a data channel transmission resource information allocated by a first access point to the user terminal, and receive data sent by a second access point according to the transmission information of the data channel,
wherein the data sent by the second access point through the data channel according to the transmission information of the data channel, and
the first access point sends no data through the data channel, or sends data to other user terminals than the user terminal through the data channel at a transmit power less than or equal to a first power.

As revealed in the technical solution of the present disclosure, the second access point sends data to the user terminal according to the data channel transmission resource information allocated to the user terminal and sent by the first access point, and the first access point sends no data to the user terminal on the allocated data channel, or sends data to other user terminals than the user terminal at a transmit power less than or equal to the first power, thereby avoiding interference between the second access point and the first access point in a heterogeneous network scenario and improving the transmission performance.

### BRIEF DESCRIPTION OF THE DRAWINGS

To describe technical solutions of the present disclosure more clearly, the following outlines the accompanying drawings involved in the description of the embodiments of the present disclosure. Apparently, the accompanying drawings outlined below are not exhaustive, and persons skilled in the art can derive other drawings from them without making any creative effort.

FIG. 1 is a schematic flowchart of a method for data transmission in a radio network according to an embodiment of the present disclosure;

FIG. 2 is a schematic structural diagram of a first access point in a radio network according to an embodiment of the present disclosure;

FIG. 3 is a schematic structural diagram of a second access point in a radio network according to an embodiment of the present disclosure; and

FIG. 4 is a schematic structural diagram of a user terminal according to an embodiment of the present disclosure.

### DETAILED DESCRIPTION OF THE EMBODIMENTS

In the embodiments of the present disclosure, a first access point in the radio network sends transmission information of a data channel allocated to a user terminal to a second access point, where the first access point sends no data through the data channel.

The second access point uses the data channel to send data to the user terminal according to the transmission information of the data channel allocated to the user terminal.

In practical application, the radio network may be a heterogeneous network or a homogeneous network.

In practical application, the first access point may be a macro eNodeB, a micro eNodeB, a home eNodeB, a relay station, and so on; and the second access point may be a macro eNodeB, a micro eNodeB, a home eNodeB, a relay station, and so on.

In practical application, the user terminal may be an LTE user equipment, or an LTE-A user equipment, or a relay node, or a device capable of receiving in a future radio system.

In the following description, a network technology in the radio network, namely, a heterogeneous network technology, is used as an example for describing embodiments of the present disclosure, but the technical solutions of the present disclosure is also applicable to other radio network systems.

The following describes embodiments of the present disclosure, supposing that the first access point is a serving macro eNodeB and the second access point is a serving micro eNodeB.

To make the present disclosure clearer, the following gives details about the implementation process of embodiments of the present disclosure with reference to accompanying drawings. The embodiments given herein shall not be construed as limitation of the present disclosure.

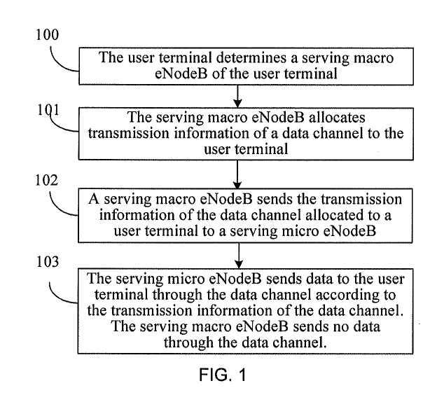

FIG. 1 is a schematic flowchart of a method for data transmission in a radio network according to an embodiment of the present disclosure. The method includes the following steps:

Step 102: A serving macro eNodeB sends transmission information of a data channel allocated to a user terminal to a serving micro eNodeB.

Specifically, through an interface between the serving macro eNodeB and the serving micro eNodeB, the serving macro eNodeB sends the transmission information of the data channel to the serving micro eNodeB, where the data channel transmission resource information is allocated by the serving macro eNodeB to the user terminal. The interface may be an interface whose delay is less than a first threshold, and the first threshold is not greater than 1 second.

Through an interface between the serving macro eNodeB and the serving micro eNodeB, the serving macro eNodeB may send a PCID (Physical Channel Identifier) of the serving macro eNodeB, data transmission subframe number, and so on, to the serving micro eNodeB.

The interface between the serving macro eNodeB and the serving micro eNodeB may be an X2 interface, or a MAC layer interface for transmitting MAC (Medium Access Control) information, or an S1 interface, or another types of interface whose propagation delay is less than 1 second. When the serving macro eNodeB and the serving micro eNodeB access a core network in a wired mode, the interface between the serving macro eNodeB and the serving micro eNodeB may be a MAC layer interface. Especially, for an LTE system, when the interface between the serving macro eNodeB and the serving micro eNodeB is a radio interface, the serving micro eNodeB may send a notification to user terminals in the cell to receive radio interface signals from the serving macro eNodeB and ensure the serving micro eNodeB to be backward-compatible with LTE users in the serving cell, where the notification indicates that a subframe currently used for receiving the radio interface signals of the serving macro eNodeB is an MBSFN (MBMS over a Single Frequency Network) subframe.

Through a control channel between the serving macro eNodeB and the user terminal, the serving macro eNodeB sends the transmission information of the data channel allocated to the user terminal to the user terminal. In an LTE system, the control channel may be a physical layer downlink control channel (PDCCH). The transmission information of the data channel allocated to the user terminal may include a radio resource occupied by the data channel, and one of or any combination of the following parameters: transmitting mode, modulation and coding scheme, power allocation information, and hybrid auto retransmission request (HARQ) information.

The serving macro eNodeB is further configured to send other common channel information designed for data transmission control to the user terminal. The common channel information includes but is not limited to primary synchronization channel information, secondary synchronization channel information, physical layer broadcast channel information, and so on.

The serving macro eNodeB does not send data such as service data and control data to the user terminal on the foregoing data channel allocated to the user terminal, but may send a first reference signal. The first reference signal is designed for channel measurement and estimation. Taking the LTE system or LTE-A system as an example, the first reference signal may be a CRS. According to the first reference signal received from the serving macro eNodeB, the user terminal may detect the transmission information of the data channel allocated to the user terminal and sent by the serving macro eNodeB to the user terminal through the control channel between the serving macro eNodeB and the user terminal, and detect other common channel information designed for data transmission control.

Step 103: The serving micro eNodeB sends data to the user terminal through the data channel according to the transmission information of the data channel. The serving macro eNodeB sends no data through the data channel, or sends data to other user terminals other than the user terminal at a transmit power less than or equal to a first power.

The first power may be set in the following way: when the serving macro eNodeB transmits data at a transmit power less than or equal to the first power, the BLER (Block Error Rate, block error rate of data demodulation) of the data sent by the serving micro eNodeB to the user terminal through the data channel is not higher than 10%.

Specifically, the serving micro eNodeB that combines with the serving macro eNodeB into an “access point set” may use the transmission information of the data channel allocated to the user terminal and received from the serving macro eNodeB, and act as an identity of the serving macro eNodeB (namely, use the PCID of the serving macro eNodeB). In this way, the back-compatibility with the LTE user terminals is ensured in the LTE-A system. Alternatively, the serving micro eNodeB acts as its own identity (namely, uses its own PCID) to send data such as service data and control data to the user terminal through the data channel allocated by the serving macro eNodeB to the user terminal. In the process above,

optionally, the serving micro eNodeB may send a second reference signal to the user terminal. The second reference signal is designed for data demodulation. Taking the LTE or LTE-A system as an example, the second reference signal may be a DRS (Dedicated Reference Signal (UE-specific Reference Signal, dedicated reference signal)) and/or a DMRS (demodulation reference signal, De-modulation Reference Signal).

According to the second reference signal received from the serving micro eNodeB, the user terminal may detect data sent by the serving micro eNodeB to the user terminal in the data channel between the serving micro eNodeB and the user terminal, where the data is service data, control data, and so on.

When allocating a data channel radio resource to the user terminal, the serving macro eNodeB may ignore CRS location of the serving micro eNodeB. Therefore, the data channel radio resource allocated by the serving macro eNodeB to the user terminal may overlap the CRS of the serving micro eNodeB. To overcome such a conflict, for ordinary user terminals, such as an LTE user terminal, the service micro eNodeB may send no data in the CRS resource location of the serving macro eNodeB and the CRS resource location of the serving micro eNodeB. When the serving micro eNodeB performs physical resource mapping, data in the CRS resource location permitted by the PDSCH mapping rule should be punctured, namely, screened off. For advanced user terminals, such as LTE-A user terminals, the serving micro eNodeB may formulate new physical resource mapping rules to avoid overlap between the data channel resources allocated by the serving macro eNodeB to the user terminal and the CRS of the serving micro eNodeB.

After receiving data such as service data and control data sent by the serving micro eNodeB, the user terminal may check whether the received data is correct. If the received data is correct, the user terminal may send an ACK (ACKnowledge, acknowledge response) signal to the serving macro eNodeB; or else, the user terminal may send a NACK (Not Acknowledge, not acknowledge response) signal to the serving macro eNodeB. When receiving a NACK signal, the serving macro eNodeB may instruct the serving micro eNodeB to retransmit data to the user terminal.

Optionally, the user terminal may send the ACK/NACK signal to the serving micro eNodeB, and the serving micro eNodeB forwards the ACK/NACK signal to the serving macro eNodeB. When receiving the NACK signal, the serving macro eNodeB may instruct the serving micro eNodeB to retransmit data to the user terminal.

Optionally, before step 102, the method may include step 100 and step 101:

Step 100: The user terminal determines a serving macro eNodeB of the user terminal.

Specifically, according to strength of the received downlink signal of each macro eNodeB, the user terminal may select the macro eNodeB with the strongest signal as a serving macro eNodeB, start a radio access process, and communicate with the selected serving macro eNodeB.

Step 101: The serving macro eNodeB allocates transmission information of a data channel to the user terminal.

The transmission information of the data channel allocated to the user terminal may be: a radio resource occupied by the data channel, and one of or any combination of the following parameters: transmitting mode, modulation and coding scheme, power allocation information, and hybrid auto retransmission request (HARQ) information.

The radio resource occupied by the data channel primarily include: frequency resource and/or time resource and/or other radio resource. In an LTE system, the data channel may be a physical layer downlink shared channel (PDSCH).

Specifically, the serving macro eNodeB may allocate the transmission information of the data channel to the user terminal according to a quality parameter of a channel between the serving macro eNodeB and the user terminal reported by the user terminal, and/or a quality parameter of a channel between the serving micro eNodeB and the user terminal. Taking the LTE or LTE-A system as an example, the allocation process may be:

The user terminal performs detection according to a first reference signal such as a CRS (Cell-specific Reference Signal) sent by the serving macro eNodeB, and reports the quality parameter of the channel between the serving macro eNodeB and the user terminal to the serving macro eNodeB. The quality parameter of the channel may be one of or any combination of the following parameters: CQI (Channel Quality Indicator), RI (Rank Indicator), PMI (Pre-coding Matrix Indicator), and RSRP (Reference Signal Received Power). The user terminal may report the quality parameter, such as RSRP, of the channel between the user terminal and the serving micro eNodeB to the serving macro eNodeB. Certain user terminals capable of detecting the CRS of the neighboring cell, such as LTE-A user terminal, may detect according to the CRS of the serving micro eNodeB, and report other quality parameter of the channel than the RSRP, such as CQI, RI, PMI, and so on, and feed back one of or any combination of the foregoing quality parameter of the channel to the serving macro eNodeB.

Supposing that the transmission information of the data channel allocated to the user terminal is the transmitting mode, the serving macro eNodeB may set the transmitting mode for data transmission of the user terminal according to information fed back by the user terminal, namely, a quality parameter of a channel between the user terminal and the serving macro eNodeB and/or a quality parameter of a channel between the user terminal and the serving micro eNodeB. The transmitting mode includes but is not limited to a data transmitting mode supported by the user terminal.

Supposing that the data channel transmission information allocated to the user terminal is a modulation and coding scheme, for the user terminal not capable of detecting the CRS of the neighboring cell, such as an LTE user equipment, the serving macro eNodeB may set a modulation and coding scheme for the user terminal according to the serving micro eNodeB's RSRP fed back by the user terminal. For the user terminal capable of detecting the CRS of the neighboring cell, such as an LTE-A user equipment, the channel state information such as CQI, RI, and PMI of the channel between the user terminal and the serving micro eNodeB can be fed back. Therefore, the serving macro eNodeB may set a modulation and coding scheme for the user terminal according to the channel state information of the channel between the serving micro eNodeB and the user terminal fed back by the user terminal.

In the foregoing step, the user terminal can obtain the transmission information of the data channel allocated to the user terminal from the serving macro eNodeB. Therefore, after receiving the transmission information of the data channel allocated to the user terminal and sent by the serving macro eNodeB, the serving micro eNodeB may keep from sending the information to the user terminal to avoid cross interference between control channels of the serving macro eNodeB and the serving micro eNodeB, and ensure the user terminal to reliably receive the transmission information of the data channel allocated to the user terminal.

Optionally, before step 102 and after step 100, the serving macro eNodeB may select a serving micro eNodeB for the user terminal.

Upon receiving a downlink signal of the micro eNodeB, the user terminal reports RSRP of the micro eNodeB to the serving macro eNodeB. In practical application, the user terminal may receive downlink signals of multiple micro eNodeBs, and report RSRP of multiple micro eNodeBs to the serving macro eNodeB.

According to the RSRP of multiple micro eNodeBs reported by the user terminal, the serving macro eNodeB selects a serving micro eNodeB for the user terminal. The selection of the serving micro eNodeB may be based on the strength of the received power.

The serving macro eNodeB of the user terminal, and the serving micro eNodeB selected by the serving macro eNodeB for the user terminal, make up an access point set for serving the user terminal.

In this embodiment, when sending control channel information to the user terminal, the serving macro eNodeB keeps from sending data; when sending data to the user terminal, the serving micro eNodeB keeps from sending control channel information, thereby avoiding cross interference of channels between the serving macro eNodeB and the serving micro eNodeB in a heterogeneous network scenario, and improving data transmission performance.

Persons skilled in the art should understand that all or a part of the steps of the methods according to the embodiments may be implemented by a computer program instructions-related hardware. The program may be stored in a computer readable storage medium. When the program is implemented, the steps of the methods according to the embodiments are performed. The storage medium may be a magnetic disk, an optical disk, a read-only memory (Read-Only Memory, ROM), or a random access memory (Random Access Memory, RAM).

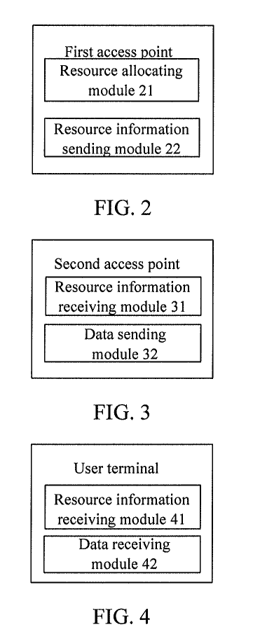

Corresponding to the foregoing method embodiments, a first access point in a radio network is provided in an embodiment of the present disclosure. As shown in FIG. 2, the first access point includes a resource allocating module 21 and a resource information sending module 22.

The resource allocating module 21 is configured to allocate transmission information of a data channel to a user terminal.

The transmission information of the data channel allocated to the user terminal may be: a radio resource occupied by the data channel, and one of or any combination of the following parameters: transmitting mode, modulation and coding scheme, power allocation information, and hybrid auto retransmission request (HARQ) information.

The radio resource occupied by the data channel primarily include: frequency resource and/or time resource and/or other radio resource. In the LTE system, the data channel may be a physical layer downlink shared channel (PDSCH).

Specifically, the resource allocating module 21 may allocate the transmission information of the data channel to the user terminal according to a quality parameter of a channel between the first access point and the user terminal reported by the user terminal, and/or a quality parameter of a channel between the second access point and the user terminal.

This quality parameter of the channel may be one of or any combination of the following parameters: CQI (Channel Quality Indicator, channel quality indicator), RI (Rank Indicator, rank indicator), PMI (Pre-coding Matrix Indicator, precoding matrix indicator), and RSRP (Reference Signal Received Power, reference signal received power).

The resource information sending module 22 is configured to send to a second access point the transmission information of the data channel allocated to the user terminal.

Specifically, the resource information sending module 22 sends the transmission information of the data channel allocated to the user terminal to the second access point through an interface between the first access point and the second access point. The interface between the first access point and the second access point may be an interface whose delay is less than a first threshold, where the first threshold is not greater than 1 second.

The first access point sends no data through the data channel, or sends data to other user terminals than the user terminal through the data channel at a transmit power less than or equal to a first power.

The first power may be set in the following way: when the serving macro eNodeB transmits data at the transmit power less than or equal to the first power, the BLER (Block Error Rate, block error rate of data demodulation) of the data sent by the serving micro eNodeB to the user terminal through the data channel is not higher than 10%.

The first access point may further include:
a second access point selecting module, configured to select a second access point for the user terminal; and
a reference information sending module, configured to send a first reference signal to the user terminal by using the data channel.

The sending module of transmission information of the data channel is further configured to send the transmission information of the data channel allocated to the user terminal to the user terminal through a control channel between the first access point and the user terminal, enabling the user terminal receiving the data sent by the second access point to the user terminal through the data channel according to the transmission information of the data channel.

The first access point may be a serving macro eNodeB of the user terminal.

In this embodiment, the second access point sends data to the user terminal according to the transmission information of the data channel allocated to the user terminal and sent by the first access point, and the first access point sends no data to the user terminal on the allocated data channel, thereby avoiding interference between the second access point and the first access point in a heterogeneous network scenario and improving the transmission performance.

Corresponding to the foregoing method embodiments, a second access point in a radio network is provided in an embodiment of the present disclosure. As shown in FIG. 3, the second access point includes the following modules:
a resource information receiving module 31, configured to receive transmission information of a data channel allocated by a first access point to a user terminal; and
a data sending module 32, configured to send data to the user terminal through the data channel according to the transmission information of the data channel, where
the first access point sends no data through the data channel, or sends data to other user terminals than the user terminal through the data channel at a transmit power less than or equal to a first power; and
the first power may be set in the following way: when the serving macro eNodeB transmits data at the transmit power less than or equal to the first power, the BLER (Block Error Rate, block error rate of data demodulation) of the data sent by the serving micro eNodeB to the user terminal through the data channel is not higher than 10%.

The data sending module 32 is specifically configured to send data to the user terminal through the data channel as an identity of the first access point or an identity of the second access point according to the transmission information of the data channel allocated to the user terminal and received from the first access point.

The second access point may be a serving micro eNodeB of the user terminal.

Corresponding to the foregoing method embodiments, a user terminal is provided in an embodiment of the present disclosure. As shown in FIG. 4, the user terminal includes the following modules:
a resource information receiving module 41, configured to receive transmission information of a data channel allocated by a first access point to a user terminal; and
a data receiving module 42, configured to receive data sent by a second access point according to the transmission information of the data channel,
wherein the data is sent by the second access point through the data channel according to the transmission information of the data channel, and
the first access point sends no data through the data channel, or sends data to other user terminals than the user terminal through the data channel at a transmit power less than or equal to a first power.

Overall, the embodiments of the present disclosure provide a new solution to radio network data transmission. The serving macro eNodeB sends the transmission information of the data channel allocated to the user terminal, and keeps from sending data on the corresponding data channel. The serving micro eNodeB sends data to the user terminal through the data channel corresponding to the transmission information of the data channel allocated by the serving macro eNodeB to the user terminal. This solution avoids interference between control channels of different access points in the radio network system, thereby ensuring the user terminal to reliably receive the control channel of the serving node, and ensuring efficient data communication between the user terminal and the serving node.

In embodiments of the present disclosure, the user terminal can make full use of the control signal quality of the macro eNodeB, improve the reliability of receiving the control channel, and make full use of the resources of the micro cell for data transmission.

For the LTE and the LTE-A systems, the data transmission mode provided herein is also transparent to the user terminal (namely, LTE user terminal) not capable of coordinated receiving, namely, ensures back-compatibility with LTE user equipment.

The above descriptions are merely preferred embodiments of the present disclosure, but not intended to limit the protection scope of the present disclosure. Any modifications, variations or replacement that can be easily derived by those skilled in the art shall fall within the protection scope of the present disclosure. Therefore, the protection scope of the present disclosure is subject to the appended claims.

What is claimed is:

1. A method for data transmission in a radio network, comprising:
sending, by a first access point, transmission information of a data channel allocated to a user terminal to a second access point,
enabling the second access point sending data to the user terminal through the data channel according to the transmission information of the data channel;
wherein the first access point sends no data through the data channel, or sends data to other user terminals than the user terminal through the data channel at a transmit power less than or equal to a first power.

2. The method according to claim 1, wherein:
before the first access point sending the transmission information of the data channel allocated to the user terminal to the second access point, the method further comprises:
selecting, by the first access point, the second access point for the user terminal.

3. The method according to claim 1, wherein:
before the first access point sends the data channel transmission resource information allocated to the user terminal to the second access point, the method further comprises:
allocating, by the first access point, the transmission information of the data channel to the user terminal according to any one or any combination of: a quality parameter of a channel between the first access point and the user terminal reported by the user terminal, and a quality parameter of a channel between the second access point and the user terminal.

4. The method according to claim 1, wherein:
the first access point sending the transmission information of the data channel allocated to the user terminal to the second access point comprises:
sending, by the first access point, the transmission information of the data channel allocated to the user terminal to the second access point through an interface between the first access point and the second access point, wherein
the interface between the first access point and the second access point comprises: an interface whose delay is less than a first threshold, wherein the first threshold is not greater than 1 second.

5. The method according to claim 1, wherein:
the transmission information of the data channel allocated to the user terminal comprises a radio resource occupied by the data channel, and one of or any combination of the following parameters: a transmitting mode, a modulation and coding scheme, power allocation information, and hybrid auto retransmission request (HARQ) information.

6. The method according to claim 1, further comprising:
sending, by the first access point, a first reference signal to the user terminal through the data channel.

7. The method according to claim 1, further comprising
sending, by the first access point, the transmission information of the data channel allocated to the user terminal to the user terminal through a control channel between the first access point and the user terminal, enabling the user terminal receiving the data sent by the second access point to the user terminal through the data channel according to the transmission information of the data channel.

8. The method according to claim 1, wherein:
after the second access point sending the data to the user terminal through the data channel according to the transmission information of the data channel, the method further comprises:
receiving, by the first access point, an acknowledge (ACK) signal or a Not acknowledge (NACK) signal sent by the user terminal with respect to the data sent by the second access point; and, instructing, by the first access point, the second access point to retransmit the data sent by the second access point to the user terminal when the first access point receives the NACK signal.

9. The method according to claim 1, wherein:
receiving, by the first access point, the acknowledge (ACK) signal or the Not acknowledge (NACK) signal sent by the user terminal and forwarded by the second access point with respect to the data sent by the second access point; and, instructing, by the first access point, the second access point to retransmit the data sent by the second access point to the user terminal when the first access point receives the NACK signal.

10. The method according to claim 1, further comprising:
sending, by the first access point, common channel information used for data transmission control to the user terminal, wherein the common channel information comprises at least one of following: primary synchronization channel information, secondary synchronization channel information and physical layer broadcast channel information.

11. A first access point in a radio network, comprising:
a processor, configured to allocate transmission information of a data channel to a user terminal; and
a transmitter, configured to send to a second access point the transmission information of the data channel allocated to the user terminal, wherein
the first access point sends no data through the data channel, or sends data to other user terminals than the user terminal through the data channel at a transmit power less than or equal to a first power.

12. The first access point according to claim 11, wherein the processor is further configured to select the second access point for the user terminal.

13. The first access point according to claim 11, wherein
the transmitter is further configured to send a first reference signal to the user terminal through the data channel.

14. The first access point according to claim 11, wherein
the transmitter is further configured to send the transmission information of the data channel allocated to the user terminal to the user terminal through a control channel between the first access point and the user terminal, enabling the user terminal receiving the data sent by the second access point to the user terminal through the data channel according to the transmission information of the data channel.

15. A second access point in a radio network, comprising:
a receiver, configured to receive transmission information of a data channel allocated by a first access point to a user terminal; and
a transmitter, configured to send data to the user terminal through the data channel according to the transmission information of the data channel,
wherein the first access point sends no data through the data channel, or sends data to other user terminals than the user terminal through the data channel at a transmit power less than or equal to a first power.

16. The second access point according to claim 15, wherein:
the transmitter is configured to send data to the user terminal through the data channel as an identity of the first access point or an identity of the second access point according to the transmission information of the data channel.

17. The method according to claim 15, wherein:
the receiver is further configured to receive an instruction from the first access point, when the first access point receives a Not acknowledge (NACK) signal sent by the user terminal with respect to the data sent by the second access point; and
the transmitter is further configured to retransmit the data sent by the second access point to the user terminal according to the instruction.

18. A user terminal, comprising:
a receiver, configured to receive transmission information of a data channel allocated by a first access point to the user terminal and
receive data sent by a second access point according to the transmission information of the data channel,
wherein the data is sent by the second access point through the data channel according to the transmission information of the data channel, and
the first access point sends no data through the data channel, or sends data to other user terminals than the user terminal through the data channel at a transmit power less than or equal to a first power.

19. The user terminal according to claim 19, wherein:
the transmission information of the data channel allocated to the user terminal comprises a radio resource occupied by the data channel, and one of or any combination of the following parameters: a transmitting mode, a modulation and coding scheme, power allocation information, and hybrid auto retransmission request (HARQ) information.

20. The user terminal according to claim 18, wherein
the transmitter is further configured to send an acknowledge (ACK) signal or a Not acknowledge (NACK) signal to the first access point with respect to the data sent by the second access point.
